(19) United States
(12) Patent Application Publication
(10) Pub. No.: US 2022/0379973 A1
(43) Pub. Date: Dec. 1, 2022

(54) FLOORING AND FLOOR PANELS AND VEHICLES INCLUDING THEM

(71) Applicants: Troy Robertz, Lake Orion, MI (US); Peter Evers, Byron, MI (US); Joseph Dumeah, Fenton, MI (US); Rick Ambers, Goshen, IN (US); Arturo Lopez, Bremen, IN (US)

(72) Inventors: Troy Robertz, Lake Orion, MI (US); Peter Evers, Byron, MI (US); Joseph Dumeah, Fenton, MI (US); Rick Ambers, Goshen, IN (US); Arturo Lopez, Bremen, IN (US)

(21) Appl. No.: 17/569,160

(22) Filed: Jan. 5, 2022

Related U.S. Application Data
(60) Provisional application No. 63/134,117, filed on Jan. 5, 2021.
(60) Provisional application No. 63/162,066, filed on Mar. 17, 2021.

(51) Int. Cl. B62D 25/20; B29C 70/08; B29C 70/10; B32B 3/12; B32B 27/06; B32B 27/20; B32B 27/32; B32B 27/30; B32B 15/04; B32B 15/18; B32B 7/12; B32B 7/08

(52) U.S. Cl. CPC B62D 25/20; B29C 70/088; B29C 70/10; B32B 3/12; B32B 27/065; B32B 27/20; B32B 27/32; B32B 27/302; B32B 15/046; B32B 15/18; B32B 7/12; B32B 7/08; B29L 2009/00

(57) ABSTRACT

Flooring and floor panels are described that include a multi-layer tape. The multi-layer tape can include two or more layers at least one of which can include a unidirectional orientation of fibers. In some configurations, the panels can include a tape with multiple layers where each layer of the tape includes a unidirectional orientation of fibers, which may be the same or may be different. Vehicles and other devices including the panels are also described.

### PRIORITY APPLICATION

This application is related to and claims priority to and the benefit of each of U.S. Provisional Application No. 63/134,117 filed on Jan. 5, 2021 and U.S. Provisional Application No. 63/162,066 filed on Mar. 17, 2021. The entire disclosure of each of these applications is hereby incorporated herein by reference.

### TECHNOLOGICAL FIELD

Certain configurations described herein are directed to flooring and floor panels. In some examples, the flooring can be used can be used in recreational vehicles or in building applications.

### BACKGROUND

Flooring is often subject to high forces and stresses in addition to water, dirt and other materials. Existing flooring is typically produced using wood-based materials. Exposure of the wood-based flooring to water, dirt and high impact forces often damages the flooring.

### SUMMARY

Certain aspects, configurations, embodiments and examples are described of flooring and floor panels that can be used in recreational vehicles or building applications or in other applications.

In an aspect, a floor panel comprises a tape layer, a reinforced thermoplastic layer, a spacer layer, and a support layer. In certain embodiments, the tape comprises a plurality of fibrous layers coupled to each other, wherein at least two fibrous layers of the tape comprise a unidirectional orientation of fibers and wherein the tape comprises at least two fibrous layers with different unidirectional fiber orientations. In some embodiments, the reinforced thermoplastic layer is coupled to a first surface of the tape at a first surface of the lightweight reinforced thermoplastic layer, wherein the reinforced thermoplastic layer comprises a web of open cell structures formed by reinforcing materials held in place by a thermoplastic material. In other embodiments, the spacer layer, e.g., a foam layer, is coupled to a second surface of the reinforced thermoplastic layer at a first surface of the foam layer. In some configurations, the support layer is coupled to a second surface of the foam layer.

In certain embodiments, each fibrous layer of the tape comprises a binder to hold the fibers in the unidirectional orientation, and wherein the tape comprises an outer layer, e.g., a film, frim, scrim, etc., on the first surface of the tape and on a second surface of the tape. In some embodiments, the support layer comprises a metal. For example, the support layer may comprise one or more of galvanized steel, aluminum, or other metal containing materials. In other instances, the support layer may comprise a reinforced thermoplastic layer, a non-metal layer, a plastic layer, or a tape layer. In some embodiments, the support layer comprises a second reinforced thermoplastic layer comprising a web of open cell structures formed by reinforcing materials held in place by a thermoplastic material. In other embodiments, the floor panel comprises a cover layer disposed on the tape layer. In some examples, the cover layer comprises one or more of a scrim, a fabric, a plastic, a laminate, wood or combinations thereof.

In certain embodiments, the tape is a two layer tape with two individual fibrous layers coupled to each other. For example, the tape may include a first fibrous layer coupled to a second fibrous layer, wherein a unidirectional fiber orientation in the first fibrous layer is orthogonal to a unidirectional fiber orientation in the second fibrous layer.

In other embodiments, the tape is a four layer tape with four individual fibrous layers coupled to each other. For example, a first fibrous layer is coupled to a second fibrous layer, and wherein a unidirectional fiber orientation in the first fibrous layer is orthogonal to a unidirectional fiber orientation in the second fibrous layer. In other embodiments, a third fibrous layer of the tape is coupled to the second fibrous layer of the tape, and wherein a unidirectional fiber orientation in the third fibrous layer is orthogonal to the unidirectional fiber orientation in the second fibrous layer. In additional embodiments, a fourth fibrous layer of the tape is coupled to the third fibrous layer of the tape, and wherein a unidirectional fiber orientation in the fourth fibrous layer is orthogonal to the unidirectional fiber orientation in the third fibrous layer. In some examples, a fourth fibrous layer of the tape is coupled to the third fibrous layer of the tape, and wherein a unidirectional fiber orientation in the fourth fibrous layer is parallel to the unidirectional fiber orientation in the third fibrous layer.

In other embodiments, a third fibrous layer of the tape is coupled to the second fibrous layer of the tape, and wherein a unidirectional fiber orientation in the third fibrous layer is parallel to the unidirectional fiber orientation in the second fibrous layer. In some examples, a fourth fibrous layer of the tape is coupled to the third fibrous layer of the tape, and wherein a unidirectional fiber orientation in the fourth fibrous layer is orthogonal to the unidirectional fiber orientation in the third fibrous layer. In other embodiments, a fourth fibrous layer of the tape is coupled to the third fibrous layer of the tape, and wherein a unidirectional fiber orientation in the fourth fibrous layer is parallel to the unidirectional fiber orientation in the third fibrous layer.

In certain configurations, the tape is a six layer tape with six individual fibrous layers coupled to each other. In other embodiments, a first fibrous layer of the tape is coupled to a second fibrous layer of the tape, and wherein a unidirectional fiber orientation in the first fibrous layer is orthogonal to the unidirectional fiber orientation in the second fibrous layer. In other embodiments, a first fibrous layer of the tape is coupled to a second fibrous layer of the tape, and wherein a unidirectional fiber orientation in the first fibrous layer is parallel to the unidirectional fiber orientation in the second fibrous layer.

In certain embodiments, the tape comprises two to six individual fibrous layers each of which comprises a unidirectional fiber orientation. The reinforced thermoplastic layer comprises a polyolefin and inorganic reinforcing fibers. The spacer layer is a foam layer comprising an expandable polystyrene foam and wherein the support layer comprises galvanized steel.

In other embodiments, the tape comprises two to six individual fibrous layers each of which comprises a unidirectional fiber orientation. The reinforced thermoplastic layer comprises polypropylene and glass reinforcing fibers. For example, the reinforced thermoplastic layer comprises 45-60 weight percent polyolefin and a balance of inorganic reinforcing fibers so the weight percent of the polyolefin and a weight percent of the inorganic reinforcing fibers together account for 100 weight percent in the reinforced thermoplastic layer. The spacer layer is a foam layer comprising an expandable polystyrene foam and wherein the support layer comprises galvanized steel. In some embodiments, the polyolefin is polypropylene or polyethylene. In additional embodiments, the inorganic reinforcing fibers are glass reinforcing fibers.

In another embodiment, the tape comprises two to six individual fibrous layers each of which comprises a unidirectional fiber orientation. The reinforced thermoplastic layer comprises polypropylene and glass reinforcing fibers, wherein the reinforced thermoplastic layer comprises 45-60 weight percent polyolefin and a balance of inorganic reinforcing fibers so the weight percent of the polyolefin and a weight percent of the inorganic reinforcing fibers together account for 100 weight percent in the reinforced thermoplastic layer. The spacer layer is a foam layer comprising one or more of an expandable polystyrene foam, a polyurethane foam or an extruded polystyrene foam, and wherein the support layer comprises a second reinforced thermoplastic layer comprising a web of open cell structures formed by reinforcing materials held in place by a thermoplastic material. In some examples, the polyolefin is polypropylene or polyethylene. In other examples, the inorganic reinforcing fibers are glass reinforcing fibers. In certain examples, the thermoplastic material of the second reinforced thermoplastic layer comprises a polyolefin. In some embodiments, the reinforcing materials of the second reinforced thermoplastic layer comprise inorganic reinforcing fibers, e.g., glass fibers. In other configurations, the thermoplastic material of the second reinforced thermoplastic layer comprises a polyolefin and the reinforcing materials of the second reinforced thermoplastic layer comprise inorganic reinforcing fibers. The polyolefin is present in the second reinforced thermoplastic layer from 45-60 weight percent and the inorganic reinforcing fibers are present in the second reinforced thermoplastic layer at a balance weight percent so the weight percent of the polyolefin and the weight percent of the inorganic reinforcing fibers together account for 100 weight percent in the second reinforced thermoplastic layer

In another aspect, a vehicle floor comprises a first floor panel and a second floor panel, which can be abutted against each other or can overlap if desired. In certain embodiments, the first floor panel comprises a tape comprising a plurality of fibrous layers coupled to each other, wherein each fibrous layer of the tape comprises a unidirectional orientation of fibers and wherein the tape comprises at least two fibrous layers with different fiber orientations. The first floor panel can also include a reinforced thermoplastic layer coupled to a first surface of the tape at a first surface of the lightweight reinforced thermoplastic layer, wherein the reinforced thermoplastic layer comprises a web of open cell structures formed by reinforcing materials held in place by a thermoplastic material, a spacer layer coupled to a second surface of the reinforced thermoplastic layer at a first surface of the spacer layer. The first floor panel can also include a support layer coupled to a second surface of the spacer layer. In some configurations, the second floor panel comprises a tape comprising a plurality of fibrous layers coupled to each other, wherein each fibrous layer of the tape comprises a unidirectional orientation of fibers and wherein the tape comprises at least two fibrous layers with different fiber orientations. The second floor panel can also include a reinforced thermoplastic layer coupled to a first surface of the tape at a first surface of the lightweight reinforced thermoplastic layer, wherein the reinforced thermoplastic layer comprises a web of open cell structures formed by reinforcing materials held in place by a thermoplastic material. The second floor panel can also include, a spacer layer coupled to a second surface of the reinforced thermoplastic layer at a first surface of the spacer layer. The second floor panel can also include a support layer coupled to a second surface of the spacer layer. In certain arrangements, the first floor panel is positioned adjacent to the second floor panel, and a covering layer can be disposed over the adjacent positioned first floor panel and the second floor panel.

In certain embodiments, the vehicle floor comprises a third floor panel positioned adjacent to the second floor panel. If desired, a covering layer is disposed over the adjacent positioned first floor panel and the second floor panel and the adjacent positioned second floor panel and third floor panel. For example, a layer of material can be positioned over two or more of the floor panels that are abutted to each other or otherwise positioned adjacent near each other.

In some examples, the tape of each of the first floor panel and the second floor panel is independently selected from a tape comprising two, four or six individual layers, and wherein at least one layer of the tape comprises a unidirectional fiber orientation. In certain embodiments, the tape of each of the first floor panel and the second floor panel is independently selected from a tape comprising two, three, four, five or six (or more) individual layers, and wherein at least two layers of the tape comprises a unidirectional fiber orientation. In other embodiments, each of the first floor panel and the second floor panel is independently selected from a tape comprising two, three, four, five or six (or more) individual layers, and wherein each layer of the tape comprises a unidirectional fiber orientation.

In some examples, the tape of each of the first floor panel and the second floor panel comprises a scrim on each surface of the tape.

In another aspect, a vehicle, e.g., a recreational vehicle, comprises a roof, side walls coupled to the roof, and a floor coupled to the sidewalls to provide an interior space within the vehicle. In some embodiments, the floor of the vehicle comprises a first panel and optionally a second floor panel and/or third floor panel or multiple floor panels as described herein. In some embodiments, the vehicle floor may include a covering layer covering the first floor panel and the second floor panel (and any other floor panels that are present). In some examples, the tape of each of the first floor panel and the second floor panel is independently selected from a tape comprising two, four or six individual layers, and wherein at least one layer of the tape comprises a unidirectional fiber orientation. In other examples, the tape of each of the first floor panel and the second floor panel is independently selected from a tape comprising two, three, four, five or six (or more) individual layers, and wherein at least two layers of the tape comprises a unidirectional fiber orientation or wherein each layer of the tape comprises a unidirectional fiber orientation.

In an additional aspect, a kit for producing a floor comprises a reinforced thermoplastic layer comprising a web of open cell structures formed by reinforcing materials held in place by a thermoplastic material, and written or electronic instructions for coupling the reinforced thermoplastic layer to a tape layer, a spacer layer and a support layer to provide the floor.

In certain embodiments, the kit can also include one or more of the tape, the spacer layer and the support layer. Alternatively, the kit can include materials to form one or more of these other layers. For example, the kit can include a material to form a foam layer as the spacer layer, e.g., the kit can include a material to form expanded foam material, an extruded foam or a cast foam.

Additional aspects, configurations, embodiments and examples are described below.

### BRIEF DESCRIPTION OF THE SEVERAL VIEWS OF THE DRAWINGS

Certain specific illustrations are described below to facilitate a better understanding of the technology described herein with reference to the accompanying drawings in which:

FIG. 1 is a simplified illustration showing one configuration of a floor panel or flooring, in accordance with some embodiments;

FIG. 2A, FIG. 2B, FIG. 2C, and FIG. 2D are illustrations showing two plys or layers of a tape, in accordance with some examples;

FIG. 3A, FIG. 3B, FIG. 3C, FIG. 3D, and FIG. 3E are illustrations showing three plys or layers of a tape, in accordance with some examples;

FIG. 4 is an illustration showing an outer layer(s) on a tape, in accordance with certain configurations;

FIG. 5A and FIG. 5B are illustrations showing a 4-ply tape, in accordance with some embodiments;

FIG. 6A and FIG. 6B are illustrations showing a 6-ply tape, in accordance with certain embodiments;

FIG. 7A and FIG. 7B are illustrations showing different tape plys or layers, in accordance with some embodiments;

FIG. 8 is an illustration showing an adhesive layer between plys or layers of a tape, in accordance with certain examples;

FIG. 9 is an illustration showing a tape layer, a reinforced thermoplastic layer and a spacer layer, in accordance with certain configurations;

FIG. 10 is an illustration showing a tape layer, a reinforced thermoplastic layer, a spacer layer and a support layer, in accordance with certain configurations;

FIG. 11 is an illustration showing a tape layer, two reinforced thermoplastic layers, a spacer layer and a support layer, in accordance with certain configurations;

FIG. 12A and FIG. 12B are illustrations showing floor panels positioned beside each other, in accordance with some embodiments;

FIG. 13 is an illustration of a recreational vehicle, in accordance with some embodiments;

FIG. 14 is an illustration of a floor panel that was tested, in accordance with certain embodiments;

FIG. 15 is a graph showing Janka heel indent results for various materials, in accordance with certain embodiments;

FIG. 16 is a graph showing floor weight of various materials, in accordance with certain embodiments;

FIG. 17 and FIG. 18 are illustrations showing different layouts of the various layers described herein, in accordance with some embodiments;

FIG. 19 is a graph showing #10 screw retention for two tested panels and a Lauan wood panel reference; and

FIG. 20 is a graph showing knee load deflection measurements for the produced test panels and a Lauan wood panel.

It will be recognized by the person having ordinary skill in the art, given the benefit of this disclosure, that certain layers or plys may be intentionally enlarged or otherwise distorted to facilitate a more user friendly description of the technology. No particular thickness, dimensions or materials are intended to be required or implied unless indicated in the description below.

### DETAILED DESCRIPTION

It will be recognized by the person of ordinary skill in the art, given the benefit of this description, that the different layers shown in the floor panels and flooring are not necessarily shown to scale. No material is intended to be required in any one layer unless specifically indicated in the description in connection with that particular configuration. The thicknesses, arrangements and end-uses of the flooring and floor panels may vary. The different plys may be configured as a single layer ply or multiple layers, e.g., more than one layer may be present that together make up a single ply tape. In addition, a tape may comprise multiple plys where each ply has a similar or different fiber orientation than other plys of the tape.

In certain embodiments, the floor panels and articles described herein can be used in place of wood panels. For example, the floor panels and articles described herein can be impact resistance, can be resistant to rot and mold and can provide a similarly sized panel, e.g. 4 feet by 8 feet, at a lower overall weight compared to wood panels. While certain examples are described in connection with flooring and floor panels, the panels could instead be used in boats, hunting blinds, heavy trucks, as interior or exterior decking, as planks for utility trailers or in other uses where wood panels or wood planks are commonly used.

In certain embodiments, the floor panel or flooring can include a multi-layer composite that can provide one or more of impact resistance, noise reduction or other desired properties. In some embodiments, at least one layer of the floor panel or flooring comprises a multi-ply or multi-layer tape with fibrous reinforcement in each ply of the tape. For example, the floor panel or flooring may comprise a plurality of individual plys where each ply comprises a unidirectional arrangement of fibers or fiber bundles. Adjacent tape plys or layers can have the same or a different orientation of fibers. Additional layers or materials may be present between tape layers or at outer surfaces of a multi-ply tape. The exact number of plys present in the tape layer may vary from two to twelve, more particularly, from two to ten or two to eight or two to six, e.g., 2, 4, 5, 6, 7, 8, 9, 10, 11, 12 or more individual plys or layers may be present in the tape. In some configurations, each ply may comprise the same thickness, whereas in other instances different plys may have a different thickness. Similarly, the chemical composition in each ply of the tape may be the same or may be different. In some examples, the fiber composition present in each tape layer may be the same, whereas in other configurations, at least one ply of the tape comprises fibers with a different composition. The fibers present in the plys or layers of the tape may be chemically treated, if desired, to impart desired properties to the tape layer. It will be recognized by the person of ordinary skill in the art, given the benefit of this disclosure, that each layer of the tape need not include fibers. For example, where a 4-layer, 6-layer or tape with more than 3 layers is present, at least two layers of the tape may comprise a fiber orientation, but not all layers of the tape need a specific fiber orientation or even need to include fibers at all. In some instances, at least one layer of a multi-layer tape may be fiber free.

In some instances, each ply or layer of the tape generally comprises a binder and fibers arranged in a unidirectional orientation. The binder can hold the fibers in the desired orientation. For example, the binder may hold the fibers so each individual fiber or fiber bundle is parallel to another fiber or fiber bundle. The fibers present in the tape can typically be present as a fiber bundle with each fiber bundle being parallel to other fiber bundles present in the ply. For reference purposes, where fiber bundles are oriented in a zero-degree direction, the fibers/fiber bundles can be oriented parallel to a machine direction present when an underlying lightweight reinforced thermoplastic (LWRT) layer is produced. Where the fibers bundles are oriented in a 90-degree direction, the fiber bundles can be oriented parallel to a cross-direction present when an underlying lightweight reinforced thermoplastic (LWRT) layer is produced. In some instances, the fiber bundles in a ply may be oriented at an angle that is greater than zero degrees and less than 90 degrees. Illustrations of different fiber bundle angles are described in more detail below. In certain embodiments, the presence of a multi-ply tape can impart impact resistance to a flooring or floor panel comprising the multi-ply tape. For example, impact resistance of a floor panel or flooring that comprises multi-ply tape as one layer may be 230N or more as tested by ASTM D1037-12. In other examples, impact resistance of a floor panel or flooring that comprises a multi-ply tape may increase at a lower overall thickness compared to a plywood floor. For example, a flooring panel as described herein with an overall thickness from 6 mm to 7 mm can have about the same impact resistance as about 10 mm thick plywood flooring. In addition to improved impact resistance at a lower thickness, the flooring and floor panels described herein can also be resistant to rot, moisture, mold and mildew.

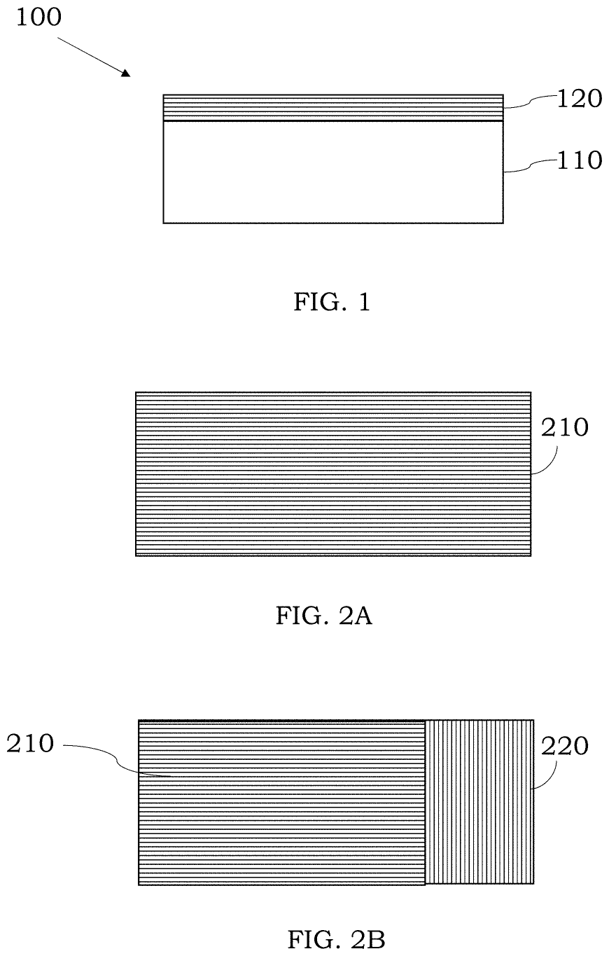

In certain embodiments, the multi-ply tapes described herein can be used in combination with a lightweight reinforced thermoplastic layer (LWRT), which is also referred to herein as simply a reinforced thermoplastic layer. An illustration is shown in FIG. 1, where a floor panel or flooring 100 includes a LWRT layer 110 coupled to a multi-ply tape 120. The LWRT layer 110 can include a thermoplastic material and reinforcing materials. For example, the LWRT layer 110 can include a web of open cell structures formed from reinforcing fibers held in place by a thermoplastic material. The LWRT layer 110 is typically highly porous and comprises a substantial amount of open cell structure such that void space is present in the layer 110. In some instances, the layer 110 may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges.

In certain embodiments, the thermoplastic material used to form the layer 110 may include one or more of a polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layer 110 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the layer 110 can vary and illustrative amounts range from about 20% by weight to about 80% by weight, e.g., 30-70 percent by weight or 35-65 percent by weight, based on the total weight of the LWRT layer 110. It will be recognized by the skilled person that the weight percentages of all materials used in the layer 110 will add to 100 weight percent.

In other embodiments, the reinforcing materials of the layer 110 may comprise glass fibers, carbon fibers, graphite fibers, synthetic organic fibers, particularly high modulus organic fibers such as, for example, para- and meta-aramid fibers, nylon fibers, polyester fibers, a high melt flow index resin (e.g., fibers with a melt flow index (MFI) or 100 g/10 min. or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, a lofting agent or other materials. The fiber content in the layer 110 may independently be from about 20% to about 90% by weight of the layer 110, more particularly from about 30% to about 70%, by weight of the layer 110. The particular size and/or orientation of the fibers used may depend, at least in part, on the thermoplastic material used and/or the desired properties of the LWRT layer 110. In one non-limiting illustration, fibers dispersed within a thermoplastic material and optionally other additives to provide the layer 110 can generally have a diameter of greater than about 5 microns, more particularly from about 2 microns to about 22 microns, and a length from about 5 mm to about 200 mm, more particularly, the fiber diameter may be from about 5 microns to about 22 microns and the fiber length may be from about 5 mm to about 75 mm. The fibers in the layer 110 typically have a random orientation.

In certain embodiments, other additives may also be present in the layer 110. For example, a lofting agent, flame retardants, colorants, smoke suppressants, surfactants, foams or other materials may be present. In some examples, the layer 110 may be substantially halogen free or halogen free layer to meet the restrictions on hazardous substances requirements for certain applications. In other instances, the layer 110 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the layer 110 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the layer 110), more particularly about 1 weight percent to about 13 weight percent, e.g., about 5 weight percent to about 13 weight percent based on the weight of the layer 110. If desired, two different halogenated flame retardants may be added or present in the layer 110. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layer 110 may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer 110), more particularly about 1 weight percent to about 13 weight percent, e.g., about 5 weight percent to about 13 weight percent based on the weight of the layer 110. If desired, two different substantially halogen free flame retardants may be added to one or more of the LWRT layers described herein. In certain instances, one or more of the LWRT layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer 110), more particularly about 1 weight percent to about 15 weight percent, e.g., about 2 weight percent to about 14 weight percent based on the weight of the layer 110. The flame retardant agents used in the LWRT layers described herein can be added to the mixture comprising the thermoplastic material and fibers (prior to disposal of the mixture on a wire screen or other processing component) or can be added after the layer 110 is formed. In some examples, the flame retardant material may comprise one or more of expandable graphite materials, magnesium hydroxide (MDH) and aluminum hydroxide (ATH).

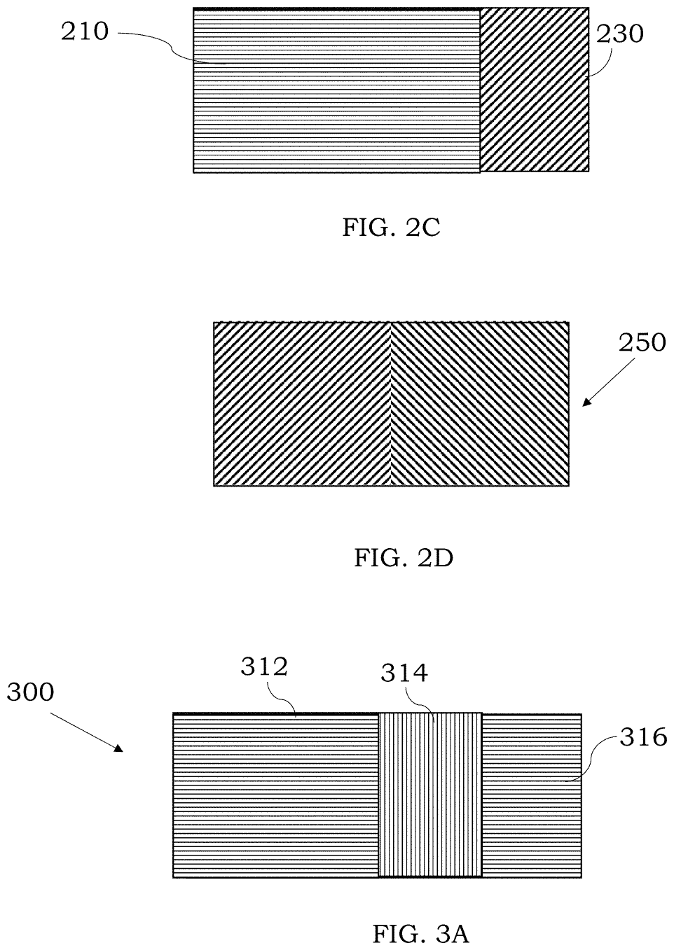

In certain embodiments, the multi-ply tape layer 120 may comprise two or more individual plys with different fiber orientations. For example and referring to FIGS. 2A and 2B, a top view of a two-ply tape is shown that comprises a first ply 210 with a first fiber orientation and a second ply 210 with a second ply orientation. For illustration purposes, a portion of the first ply 210 has been removed in FIG. 2B to permit viewing of the underlying fibers in the first ply 210. The first ply 210 has a first fiber orientation that is oriented 90 degrees to a fiber orientation in a second ply 220. For example, the fibers in the first ply 210 maybe oriented in a zero degree direction, whereas the fibers in the second ply 220 can be oriented in a 90-degree direction. These directions are illustrative and other angles may be present. For example and referring to FIG. 2C, a ply 230 with a 45-degree fiber orientation is shown. The ply 230 could instead have a different angle with respect to the zero-degree fibers in the ply 210, e.g., a, 5, 10, 15, 20, 25, 30, 35, 40, 45, 50, 55, 60, 65, 70, 75, 80, 85-degree orientation or any angle between these values. While the fiber orientation in plys 220 and 230 are all shown to be substantially parallel to each other, if desired, the fiber orientation could change across a surface of the tape. Referring to FIG. 2D, a ply 250 is shown that includes +45 degree fibers and −45 degree fibers at different areas along the ply.

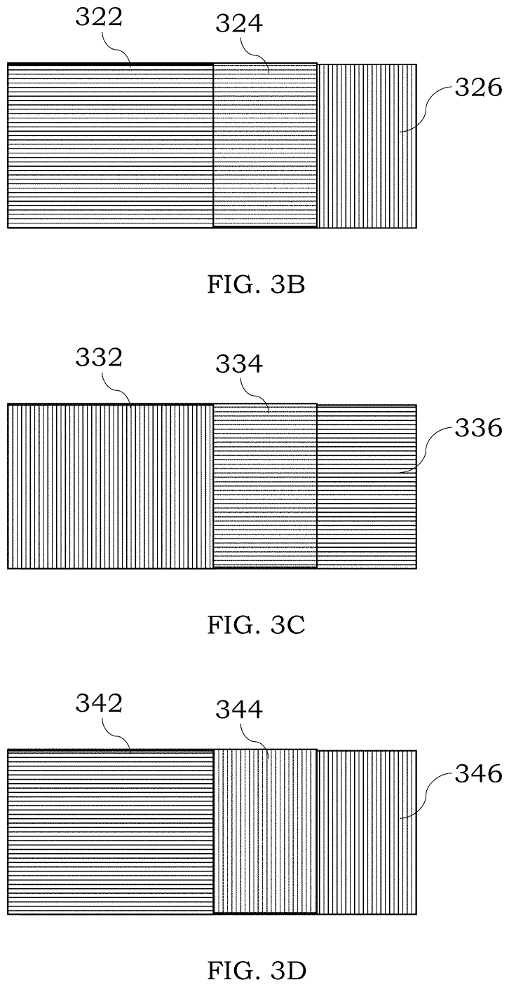

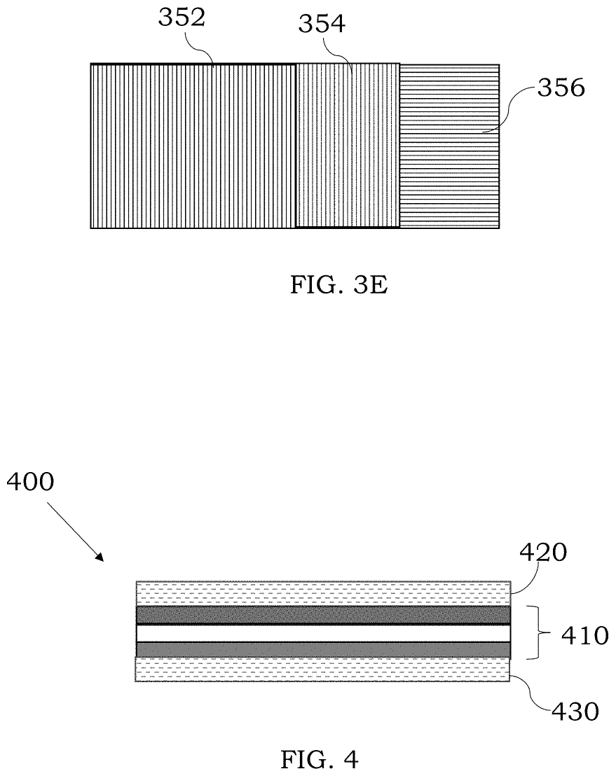

In certain examples, the tapes described herein may comprise three or more different plys or layers. Referring to FIG. 3A, a 3-ply tape 300 is shown that includes a fiber orientation (top to bottom) of 0/90/0, where a portion of the plys 312 and 314 have been removed to permit viewing of the underlying plys. For example, a first ply 312 comprises a 0-degree arrangement, a second ply 314 comprises a 90-degree fiber arrangement, and a third ply 316 comprises a 0-degree fiber arrangement. This arrangement of plys can be varied as desired. For example, FIG. 3B shows a 0/0/90 arrangement where plys 322, 324 have a 0-degree fiber arrangement and a ply 326 has a 90-degree fiber arrangement. FIG. 3C shows a 90/0/0 arrangement where a ply 332 comprises a 90-degree fiber arrangement and plys 334, 336 comprise a 0-degree fiber arrangement. FIG. 3D shows a 0/90/90 arrangement where a ply 342 comprises a 0-degree fiber arrangement and plys 344, 346 comprise a 90-degree fiber arrangement. FIG. 3E shows a 90/90/0 arrangement where plys 352, 354 comprise a 90-degree fiber arrangement and ply 356 comprises a 0-degree fiber arrangement. Other arrangements are also possible. For example, a 3-ply tape could have a 0/0/0 or a 90/90/90 fiber arrangement if desired.

In some embodiments, a multi-ply tape may comprise outer layers on each surface of the tape layers. For example and referring to FIG. 4, a tape 400 comprises 3-plys (collectively 410), a first outer layer 420 and an optional second outer layer 430. In some examples, the second outer layer 430 can be omitted if desired. The outer layers 420, 430 can act to retain the binder materials in the various plys. For example, the outer layers 420, 430 can be a film, scrim or other materials that can act to promote adhesion of the tape to other layers. The outer layers 420, 430 can be the same or can be different. In some embodiments, the outer layers 420, 430 may each independently be a polyolefin film, a fabric, a scrim (woven or non-woven), a frim (film+scrim) or may be other layers. The outer layers 420, 430 may comprise fibers or be fiber free. For example, in certain configurations, the outer layers 420, 430 each can be a fiber-based scrim that can include at least one of glass fibers, aramid fibers, graphite fibers, carbon fibers, inorganic mineral fibers, metal fibers, metalized synthetic fibers, and metalized inorganic fibers. In other configurations, the layers 420, 430 each may be a scrim that comprise materials or fibers produced from one or more of the thermoplastic materials described above in connection with the LWRT layers. In other examples, the outer layer may be printed and/or may contain anti-microbial materials or coatings.

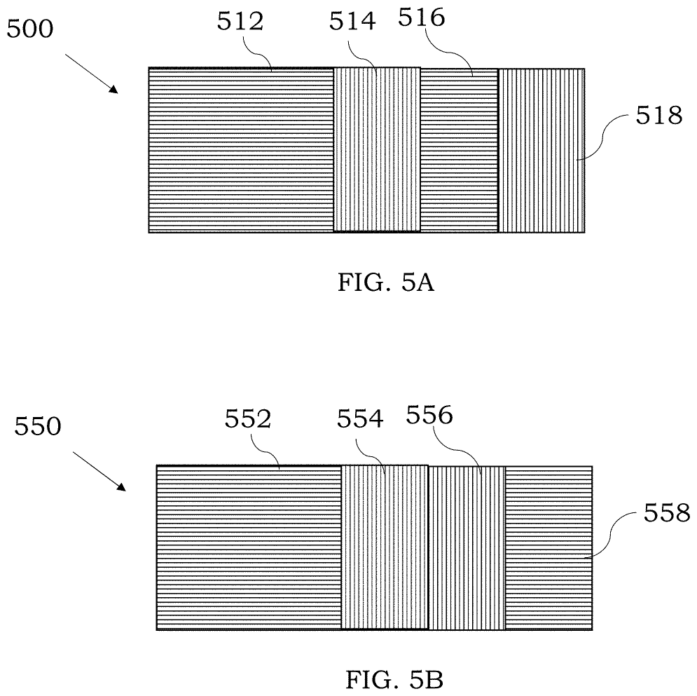

In certain embodiments, the tapes described herein may comprise more than three plys or layers. For example, the tape may comprise 4, 5, 6, 7, 8, 9, 10, 11, 12 or more individual plys. As noted herein, each ply may have a unidirectional fiber orientation or arrangement, and adjacent plys may have the same fiber arrangement, e.g., 0/0 or 90/90, or may have a different fiber arrangement, e.g., 0/90 or 90/0. Several illustrations of tapes with more than 3 plys are shown in FIGS. 5A and 5B. In FIG. 5A, a tape 500 comprises plys 512, 514, 516 and 518 with a 0/90/0/90 arrangement, respectively. In FIG. 5B, a tape 550 comprises plys 552, 554, 556 and 558 with a 0/90/90/0 arrangement. It will be recognized by the person of ordinary skill in the art, given the benefit of this disclosure, that other arrangements of the different plys are possible. For example, in a 4-layer ply a 90/0/0/90 arrangement of fibers in different plys can be present. Other fiber arrangements in a 4-ply tape include, but are not limited to, 90/0/90/0, 90/90/0/0, 90/0/0/90, 0/0/90/90, 0/90/90/90, 90/0/90/90, 90/90/0/90, 90/90/90/0, 0/0/0/90, 0/0/90/0, 0/90/0/0, and 90/0/0/0. If desired, all plys could have the same fiber arrangement, e.g., 0/0/0/0 or 90/90/90/90. As noted above in connection with the 3-ply tape, a tape with 4-plys can include outer layers, e.g., a film, scrim, frim, etc. that can function, for example, to promote adhesion of the tape to other layers.

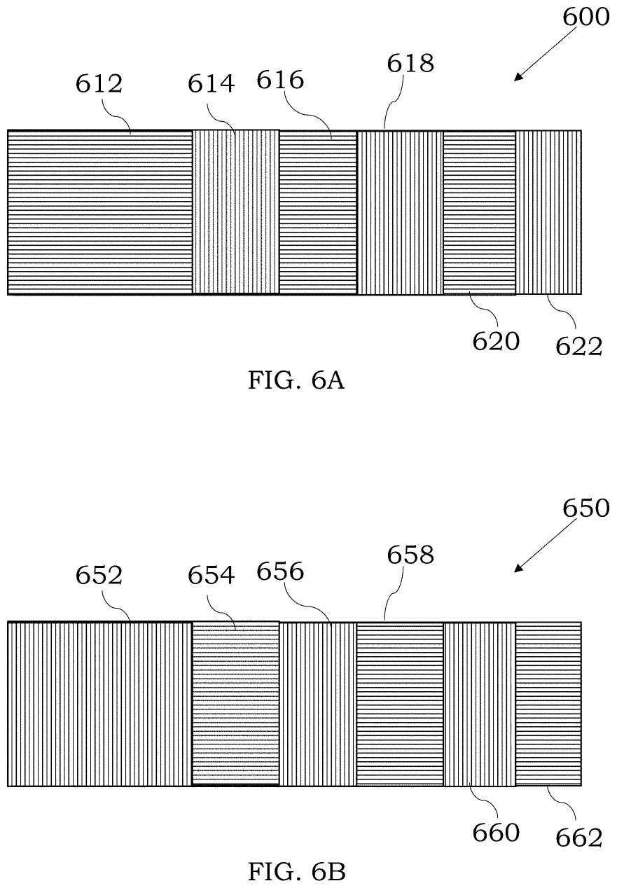

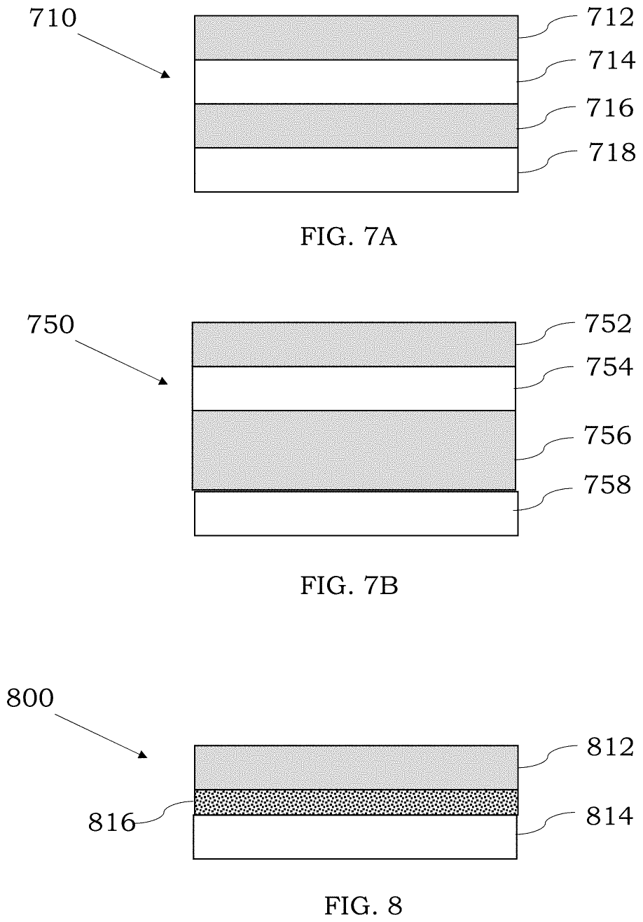

In certain embodiments, the tape may comprise 5-plys, 6-plys (FIGS. 6A and 6B), 7-plys, 8-plys or more than 8-plys. For illustration purposes, a 6-ply tape is shown in FIGS. 6A and 6B. Referring to FIG. 6A, a 6-ply tape 600 comprises plies 612, 614, 616, 618, 620 and 622 with a fiber arrangement of 0/90/0/90/0/90 respectively. Referring to FIG. 6B, a 6-ply tape 650 comprises plies 652, 654, 656, 658, 660 and 662 with a fiber arrangement of 90/0/90/0/90/0 respectively. Where a 5-ply tape is present, the fiber arrangement may be, for example, 0/90/90/0/0 or other arrangements. Where a 7-ply tape is present a fiber arrangement of 0/90/0/90/0/90/0, or other fiber arrangements, can be present. Where an 8-ply tape is present, a fiber arrangement of 0/90/0/90/0/90/0/90, or other fiber arrangements, can be present. The fiber orientation in the different tapes shown in the figures are merely for illustration and many different fiber arrangements are possible. For example, in a 6-ply tape, the different layers may have a 0/90/90/90/90/0 or a 0/90/0/0/90/0 arrangement if desired.

In certain embodiments, a thickness of each ply of the tape can be the same or different than other plys in the tape. FIG. 7A shows a 4-ply tape 710 where each ply 712, 714, 716 and 718 comprises the same thickness. FIG. 7B shows a 4-ply tape 750 where a ply 752, 754 and 758 have the same thickness and ply 756 has an increased thickness. The exact thickness of each ply may vary, for example, from about 0.05 mm (˜2 mils) to about 0.5 mm (˜20 mils), more particularly about 0.1 mm (˜4 mils) to about 0.25 mm (˜10 mils) or about 0.3 mm (˜12 mils) to about 0.35 mm (˜14 mils). After combining the different plys, the overall tape thickness can vary. In some configurations, an overall tape thickness for a 2-ply tape can be about 0.4 mm to about 0.8 mm. An overall thickness for a 4-ply tape can vary from about 0.8 mm to about 1.6 mm. An overall thickness for a 6-ply tape can vary from about 1.2 mm to about 2.4 mm. An overall thickness for an 8-ply tape can vary from about 1.6 mm to about 3.2 mm.

In certain embodiments, the different plys of the tapes can be coupled to each other through an adhesive layer. For example and referring to FIG. 8, a 2-ply tape 800 is shown that comprises a first ply 812 coupled to a second ply 814 through an adhesive layer 816. The adhesive layer 816 may comprise a thermoplastic material or a thermosetting material or both. In some embodiments, the adhesive layer 816 may comprise a material present in the binder used in one or more of the plys 812, 814. For example, the binder in the plys 812, 814 may be a thermoplastic material and that same thermoplastic material can be present in the adhesive layer 816. In some embodiments, the adhesive layer 816 may comprise one or more of a polyolefin, a polyurethane, a polyamide, a co-polyamide or combinations thereof. For example, the adhesive layer 816 may comprise polyethylene, polypropylene or combinations and co-polymers thereof. Enough adhesive is present to permit the plys 812, 814 to remain coupled to each other with minimal to no delamination when the flooring or floor panel is in use. If desired, an adhesive layer may be present between each ply or layer of a multi-ply or multi-layer tape.

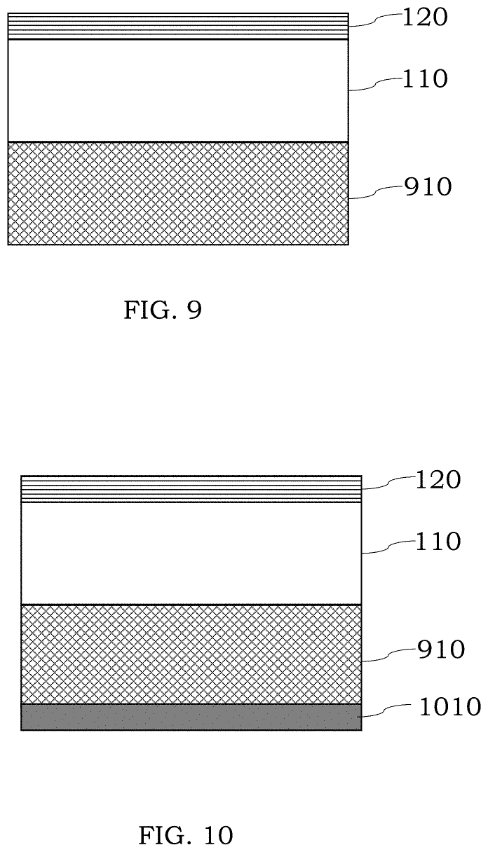

In certain embodiments, the multi-ply tape layer 120 and the LWRT layer 110 can be used in combination with a foam or other spacer layer. For example and referring to FIG. 9, a spacer layer 910, e.g., a foam layer, can be coupled to the LWRT layer 110. The spacer layer 910 can be a honeycomb layer or a layer that has open structure. In some examples, the layer 910 may comprise an expanded polystyrene foam, an extruded polystyrene foam, a polyurethane foam, or other foams. Alternatively, the layer 910 may have a honeycomb structure produced from polyurethane, cellulose or other materials. The spacer layer 910 can provide support to the flooring or floor panel and may also provide some noise reduction. While now shown, the layer 910 can be coupled to the LWRT layer 110 through an adhesive layer. Similarly, the LWRT layer 110 can be coupled to the tape layer 120 through an adhesive layer. Illustrative adhesive materials include, but are not limited to, thermoplastic adhesives and thermosetting material adhesives. For example, the adhesive layer may comprise a polyolefin, a polyurethane, a polyamide, a co-polyamide or combinations thereof. The exact thickness and weight of the spacer layer 910 may vary. In some embodiments, the spacer layer 910 may have a thickness of about 0.5 cm to about 5 cm, more particularly, about 1 cm to about 4 cm or about 3 cm to about 4 cm. Where the spacer layer 910 comprises a foam, the density of the foam may vary from about 1 pound per cubic foot (pcf) to about 5 pcf, more particularly about, 2 pcf to about 4 pcf or 2 pcf to 3 pcf. If desired, the spacer layer 910 can include additives, particles, fibers, powder or other materials.

In some configurations, one or more support layers may also be used in combination with the tape layer 120, the LWRT layer 110 and the spacer layer 910. Referring to FIG. 10, a support layer 1010 is shown. The support layer 1010 can act to hold all the other layers in place. In some embodiments, the support layer 1010 comprises a plastic, a metal, a non-metal or other materials. For example, the support layer 1010 may comprise steel, aluminum, carbon, titanium, galvanized steel or other materials. The exact thickness of the support layer 1010 can vary from about 0.5 mm to about 5 cm. Similarly, the density of the support layer 1010 may vary from about 0.2 g/cm³ to about 8.0 g/cm³ (e.g., if the support layer 1010 is made of LWRT sheets then the density may range from about 0.2 g/cm³ to about 0.8 gm/cm³). In certain embodiments, the support layer 1010 may be a LWRT layer similar to the layer 110. For example, the support layer 1010 may comprise open cell structures formed from reinforcing fibers held in place by a thermoplastic material. The support layer 1010 may be porous or non-porous as desired. In certain embodiments, the support layer 1010 may have any of those materials and properties described in connection with the LWRT layer 110.

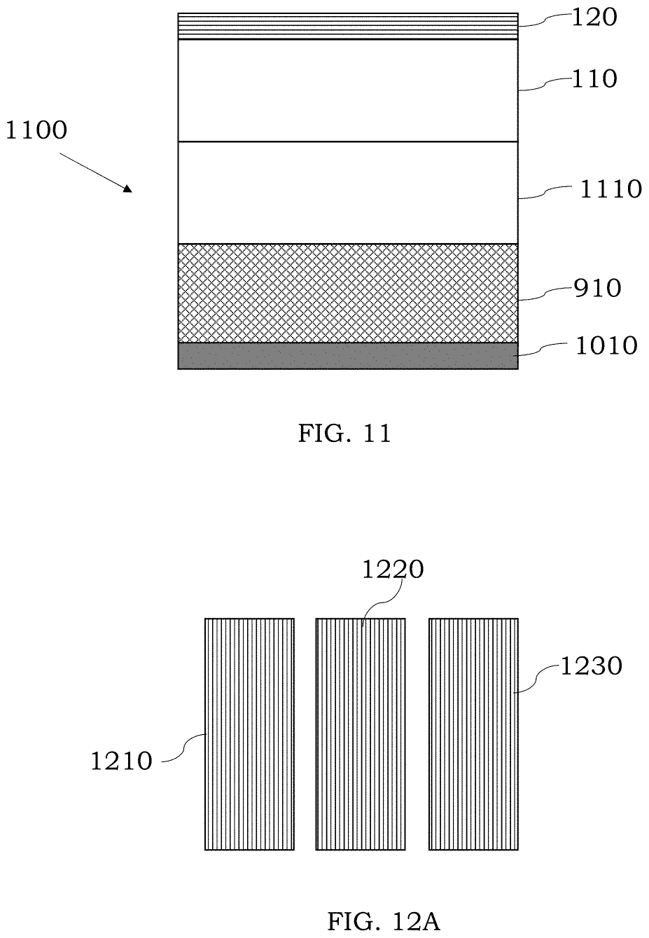

In certain embodiments, a floor panel or flooring can include two or more LWRT layers in combination with a multi-ply tape layer and optionally other layers. Referring to FIG. 11, a floor panel 1100 can include a multi-ply tape layer 120, coupled to a first LWRT layer 110. The first LWRT layer 110 can be coupled to a second LWRT layer 1110. The second LWRT layer 1110 can be coupled to a spacer layer 910, which is coupled to a support layer 910. The second LWRT layer 1110 may be configured similar to the first LWRT layer 110, e.g., the second layer 1110 may have any of those materials and properties described in connection with the LWRT layer 110. In some embodiments, the second LWRT layer 1110 may include reinforcing fibers held in place by a thermoplastic resin to form a web of open cell structures. The first LWRT layer 110 and the second LWRT layer 1110 can the same or can be different. In some embodiments, the second LWRT layer 1110 comprises a substantial amount of open cell structure such that void space is present in the layer 1110. In some instances, the layer 1110 may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges.

In certain embodiments, the thermoplastic material used to form the LWRT layer 1110 may include one or more of a polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layer 1110 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the layer 1110 can vary and illustrative amounts range from about 20% by weight to about 80% by weight, e.g., 30-70 percent by weight or 35-65 percent by weight, based on the total weight of the LWRT layer 1110. It will be recognized by the skilled person that the weight percentages of all materials used in the layer 1110 will add to 100 weight percent.

In other embodiments, the reinforcing materials of the LWRT layer 1110 may comprise glass fibers, carbon fibers, graphite fibers, synthetic organic fibers, particularly high modulus organic fibers such as, for example, para- and meta-aramid fibers, nylon fibers, polyester fibers, a high melt flow index resin (e.g., fibers with a melt flow index (MFI) or 100 g/10 min. or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, a lofting agent or other materials. The fiber content in the layer 1110 may independently be from about 20% to about 90% by weight of the layer 1110, more particularly from about 30% to about 70%, by weight of the layer 1110. The particular size and/or orientation of the fibers used may depend, at least in part, on the thermoplastic material used and/or the desired properties of the LWRT layer 1110. In one non-limiting illustration, fibers dispersed within a thermoplastic material and optionally other additives to provide the layer 1110 can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm. The fibers in the layer 1110 typically have a random orientation. The layer 1110 may also have additives as described in connection with the LWRT layer 110.

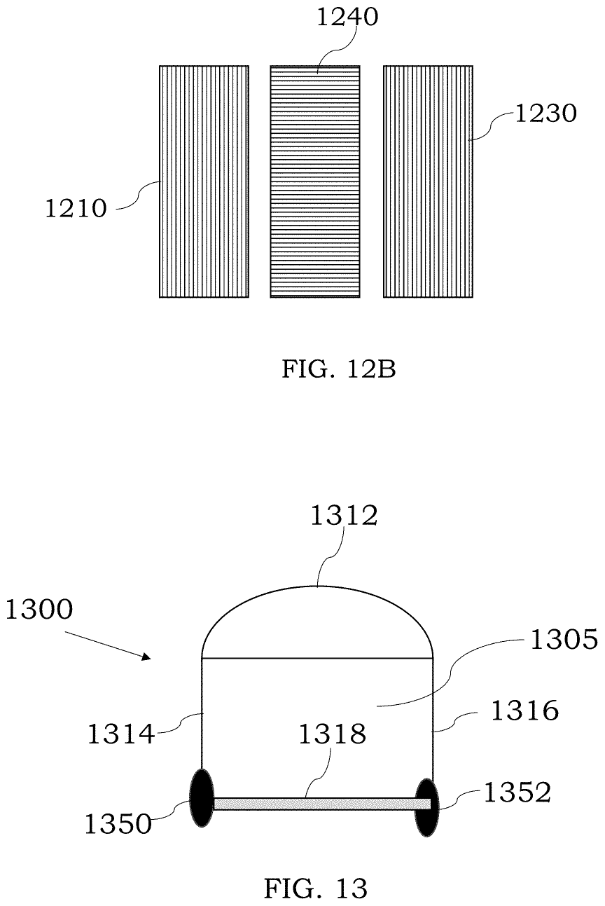

In certain embodiments, the articles described herein can be used as flooring or floor panels. Referring to FIG. 12, three panels 1210, 1220, 1230 are shown as being positioned adjacent to each other. Each panel 1210, 1220, 1230 may include any one or more of the various layers described herein. For example, panel 1210 may include a tape comprising a plurality of fibrous layers coupled to each other, wherein each fibrous layer of the tape comprises a unidirectional orientation of fibers and wherein the tape comprises at least two fibrous layers with different fiber orientations, a reinforced thermoplastic layer coupled to a first surface of the tape at a first surface of the lightweight reinforced thermoplastic layer. The panel 1210 can also include a reinforced thermoplastic layer comprising a web of open cell structures formed by reinforcing materials held in place by a thermoplastic material. The panel 1210 can also include a spacer layer coupled to a second surface of the reinforced thermoplastic layer at a first surface of the spacer layer, and a support layer coupled to a second surface of the spacer layer. Each of the panels 1210, 1220, 1230 can be the same or can be different. For example and referring to FIG. 12B, a panel 1240 with a 90-degree fiber orientation on an outer surface can be positioned between panels 1210, 1230. In use, the panels can be abutted against each other and a top layer or covering may be added to form a final vehicle floor. For example, a carpet, plastic or other covering layer may be placed on top of the panels 1210, 1220, 1230 when they are positioned against each other. The exact number of panels used in any vehicle floor may vary from 2 to about 20 or more than 20. Each of the panels 1210, 1220, 1230 may independently include a tape comprising two, three, four, five or six (or more) individual layers or plys, wherein at least one layer of the tape comprises a unidirectional fiber orientation. As noted herein, an outer layer, e.g., film, scrim, etc. can be present on one or more surfaces of the tape.

In certain configurations, the flooring and floor panels described herein may be present in a vehicle including, for example, a recreational vehicle, a van, a motorhome, a bus, a truck or other vehicles. For illustration purposes, a recreational vehicle 1300 is shown in FIG. 13 that includes a floor panel as described herein. The RV 1300 includes a roof 1312, side walls 1314, 1316 coupled to the roof 1312, and a floor 1318 coupled to the sidewalls 1314, 1316 to provide an interior space 1305 within the recreational vehicle 1300. In certain configurations, the floor may include a floor panel comprising a tape comprising a plurality of fibrous layers coupled to each other, wherein each fibrous layer of the tape comprises a unidirectional orientation of fibers and wherein the tape comprises at least two fibrous layers with different fiber orientations. The floor panel can also include a reinforced thermoplastic layer coupled to a first surface of the tape at a first surface of the lightweight reinforced thermoplastic layer, wherein the reinforced thermoplastic layer comprises a web of open cell structures formed by reinforcing materials held in place by a thermoplastic material. The floor panel can also include a spacer layer coupled to a second surface of the reinforced thermoplastic layer at a first surface of the spacer layer, and a support layer coupled to a second surface of the spacer layer. In some instances, the floor 1318 can include two, three or more floor panels as described herein. While not shown, the floor 1318 typically includes a covering layer, e.g., a fabric, tile, polymer, etc. over the floor panels. As noted herein, the floor panels can include a tape with 2 or more plys each of which can include a selected fiber orientation or arrangement.

The exact process used to produce the floors shown in FIGS. 12A-13 may vary. For example, each panel could be laminated independently and then assembled together to create a larger floor. Alternatively, a process that produces single floor laminated at one time with the seams of the individual layers overlapping could also be used. For example, the overlapping layers might be present in a selected pattern, e.g., a tile pattern, brick pattern, marble pattern etc.

In certain embodiments, the floor panels, or components thereof, may be packaged in the form of a kit that can include one or more components of the floor panel in combination with written or electronic instructions for coupling the reinforced thermoplastic layer to a tape layer. The kit can include a spacer layer and a support layer to provide the floor. In some embodiments, the kit can include a reinforced thermoplastic layer comprising a web of open cell structures formed by reinforcing materials held in place by a thermoplastic material. In other embodiments, the kit can include the tape. In additional examples, the tape comprises at least two fibrous layers coupled to each other, wherein a first fibrous layer of the tape comprises a unidirectional orientation of fibers. For example, the unidirectional fiber orientation of the first fibrous layer is orthogonal to a unidirectional fiber orientation of a second fibrous layer. In other instances, the unidirectional fiber orientation of the first fibrous layer is parallel to a unidirectional fiber orientation of a second fibrous layer. In some examples, the kit comprises the spacer layer, e.g., a foam layer. For example, the kit may include a foam layer, or materials to produce a foam layer, including one or more of an expanded foam material, an extruded foam or a cast foam. If desired, the kit can also include the support layer, e.g., a metal layer or a reinforced thermoplastic layer. For example, the support layer can include a second reinforced thermoplastic layer comprising a web of open cell structures formed by reinforcing materials held in place by a thermoplastic material.

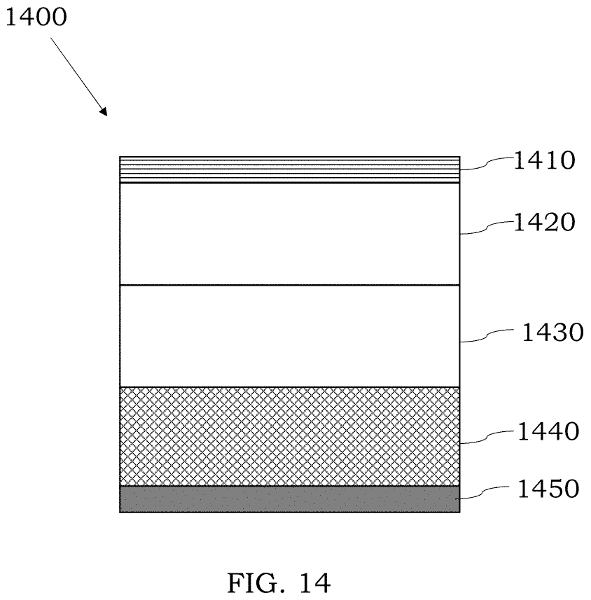

It will be recognized by the person of ordinary skill in the art, given the benefit of this disclosure, that the exact form of the various layers and/or materials described herein can vary. For example and referring to FIG. 14, the layer 1410 could include one or more of a 2-ply bi-directional glass tape (e.g., from a roll of tape), a 4-ply bi-directional glass tape (e.g., in sheet form or on a roll), a 6-ply bi-directional glass tape (e.g., in sheet form) or other multi-ply tapes in sheet form or roll form. Each of the layers 1420, 1430 can have a thickness which can vary from about 2 mm to about 6 mm and may be produced from a single layer or include more than one layer. Each of the layers 1420, 1430 can be a LWRT layer as described herein and may be the same or may be different. The layer 1440 can be produced using foam materials, non-foam materials or both. In some embodiments, the layer 1440 can be one or more of 1 lb/ft³ EPS, 1.5 lbs/ft³ EPS, 2 lbs/ft³ EPS, 3 lbs/ft³ EPS, 4 lbs/ft³ polyurethane foam or 6 lbs/ft³ polyurethane foam. In certain configurations, the layer 1450 can be one or more of a single fiber reinforced thermoplastic layer (e.g., with a thickness of 2 mm to about 6 mm), two single fiber reinforced thermoplastic layers (e.g., with an overall thickness of 2 mm to about 6 mm), a glass layer (e.g., a 2-ply glass layer, a 4-ply glass layer), a metal layer, a flame retardant layer or combinations thereof. Additional materials for the layers 1410, 1420, 1430, 1440 and 1450 can be selected by the person having ordinary skill in the art, given the benefit of this disclosure.

Certain specific examples are described to facilitate a better understanding of the technology described herein.

### EXAMPLE 1

A floor panel was constructed that included the layers shown in FIG. 14. The panel 1400 included a 4-ply tape 1410 with each layer including glass fibers arranged in a unidirectional orientation (0/90/90/0 fiber orientation). The tape included a polyethylene terephthalate scrim (not shown) on each surface. The panel includes two reinforced thermoplastic layers 1420, 1430, each of which included polypropylene (45% by weight) and glass fibers (55% by weight). A thickness of each of the layers 1420, 1430 was 2.7 mm. A foam layer 1440 (1.5 inches thick with 3 pcf EPS foam) was adjacent to the layer 1430. A galvanized steel layer 1450 was present under the foam layer 1440. This floor panel was tested in the examples below.

### EXAMPLE 2

Another floor panel was constructed that included the layers shown in FIG. 14 except the 4-ply tape was replaced with a 6-ply tape (0/90/0/90/0/90 fiber orientation). This floor panel was also tested in the examples below.

### EXAMPLE 3

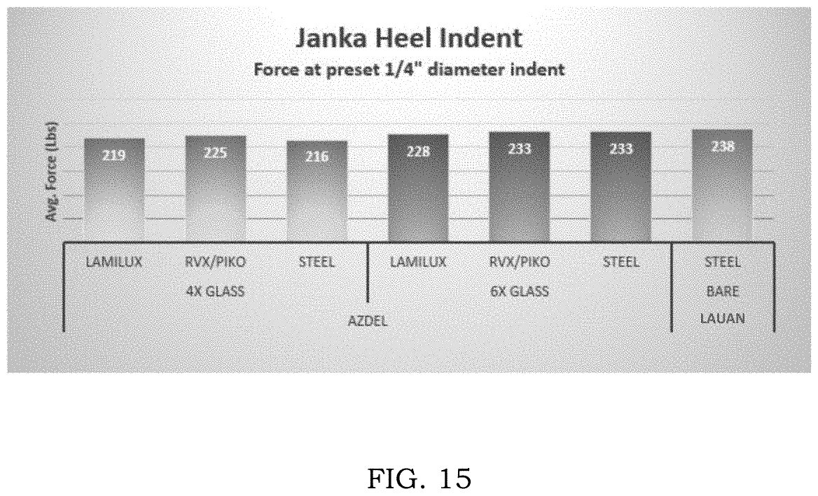

FIG. 15 shows the results of a Janka heel indent test for various materials including the floor panels of Examples 1 and 2. The Janka score represent the full load on a ½ inch stiletto. The minimum value of 216 translates to 864 psi. RVX/PIKO 4× GLASS (corresponds with 4-ply tape in example 1) represents the floor panel in of Example 1, and RVX/PIKO 46× GLASS (6× GLASS as represented by the 6-ply tape in Example 2) represents the floor panel of Example 2. All materials showed similar performance.

### EXAMPLE 4

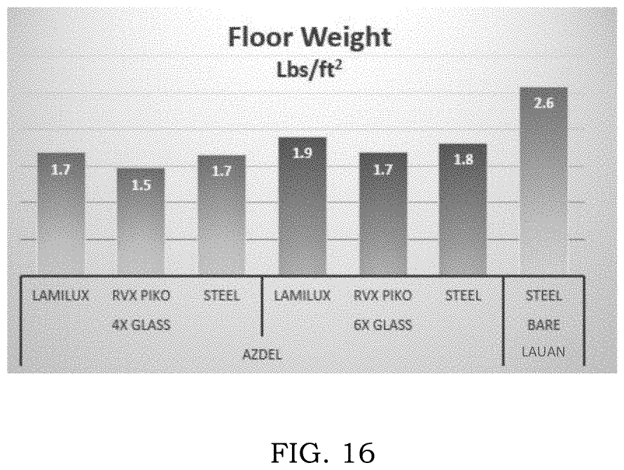

The various materials were weighed. The weight on a square foot basis is shown in FIG. 16. The floor panel of Example 1 is considerably lighter than the other materials even though it displayed similar performance characteristics.

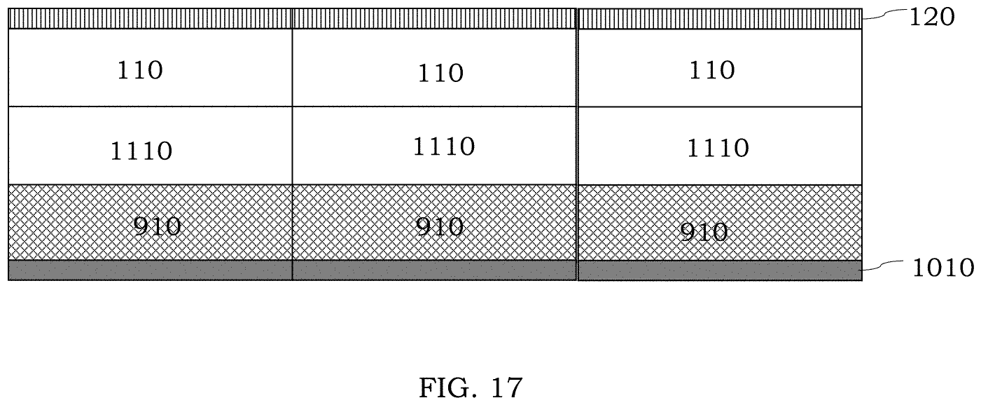

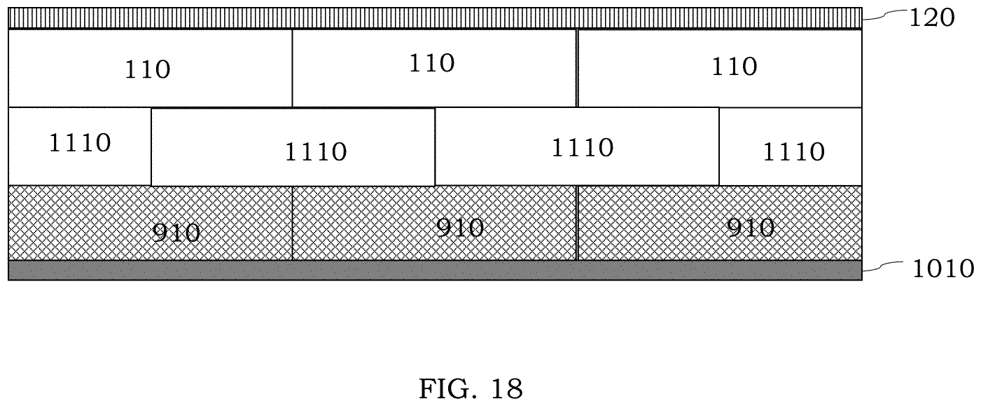

Table 1 below compares produced floor panels with wood for an 8 feet by 20 feet trailer (160 ft²). The measured floors generally included the layers shown in FIG. 11, except the wood floor was missing layer 120. Layers 910 and layer 1010 were the same for all three floors with layer 910 being 3 pcf EPS foam and layer 1010 being galvanized steel. An overall illustration of the floors is shown in FIG. 17 (abutting panels), with an alternative configuration (staggered joints) that could be used shown in FIG. 18. The configuration in FIG. 18 includes staggered joints between different layers so the joints in different layers are offset or staggered. For example, the individual layers or sheets of material can be stacked in an offset manner and then the entire assembly can be laminated together to form the floor.

For the wood floor, layers 110 and 1110 were 5.2 mm thick plywood.

For the 6× glass floor, a 6-ply glass fiber tape was used in layer 120, and a 2.7 mm thick LWRT (55% by weight glass fibers and 45% by weight polypropylene) was used for layers 110 and 1110.

For the 4× glass floor, a 4-ply glass fiber tape was used in the layer 120, and a 2.7 mm thick LWRT (55% by weight glass fibers and 45% by weight polypropylene) was used for layers 110 and 1110.

TABLE 1

| | | total | | |
|---|---|---|---|---|
| Material | lbs/ft2 | weight | | savings |
| Wood | 2.6 | 416 | Lbs. | Current |
| 6 × glass | 1.8 | 288 | Lbs. | 31% |
| 4 × glass | 1.7 | 272 | Lbs. | 35% |

The produced floor panels are significantly lighter than wood.

### EXAMPLE 5

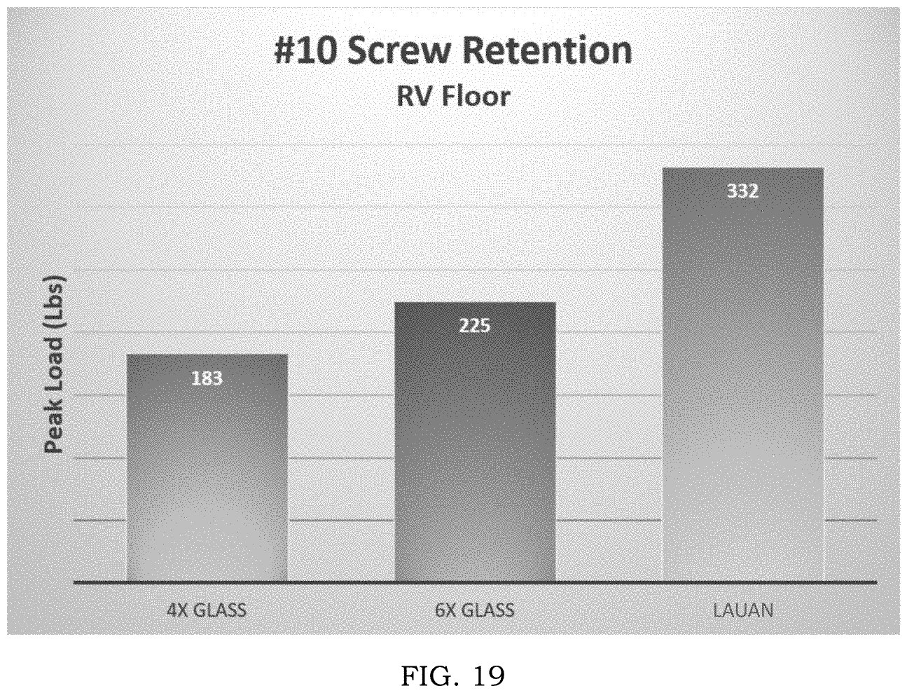

The ability of the floor panels to retain screws was measured. The results are shown in FIG. 19. The lauan reference material (which includes 2 layers of 5.2 mm thick plywood) was able to retain #10 screws better than the produced articles. For reference, 2.7 mm lauan has an average screw retention of 190 N.

### EXAMPLE 6

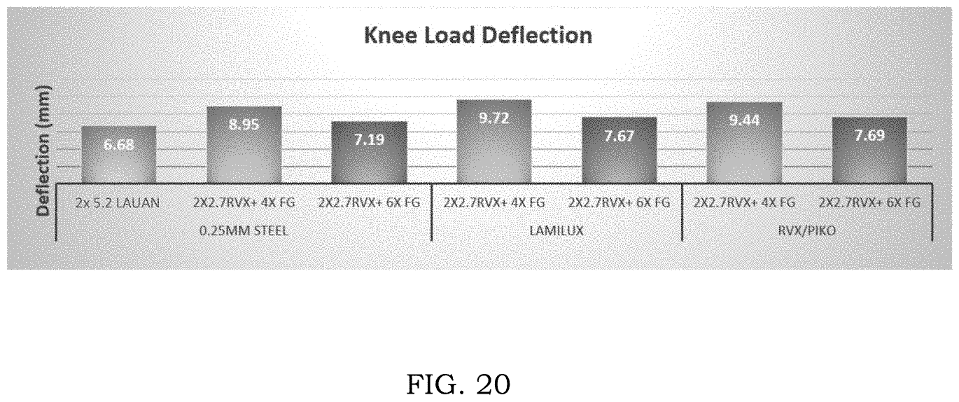

Knee load deflection was measured for the different samples (see FIG. 20). The floor panel including the 6-ply glass tape deflected only 0.5 mm more than a current Lauan wood floor panel over a 30″ by 40″ span, even though the floor panel of Example 2 had a significantly lower weight. The floor panel of Example 1 resulted in 2.3 mm more deflection than a Lauan wood floor panel. The results were consistent with the lighter 6-play glass tape panel providing similar or better deflection performance than a heavier Lauan wood floor panel.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A floor panel comprising:
a tape comprising a plurality of fibrous layers coupled to each other, wherein at least two fibrous layers of the tape comprise a unidirectional orientation of fibers and wherein the tape comprises at least two fibrous layers with different unidirectional fiber orientations;
a reinforced thermoplastic layer coupled to a first surface of the tape at a first surface of the reinforced thermoplastic layer, wherein the reinforced thermoplastic layer comprises a web of open cell structures formed by reinforcing materials held in place by a thermoplastic material;
a spacer layer coupled to a second surface of the reinforced thermoplastic layer at a first surface of the spacer layer;
a support layer coupled to a second surface of the spacer layer.

2. The floor panel of claim 1, wherein each fibrous layer of the tape comprises a binder to hold the fibers in the unidirectional orientation, and wherein the tape comprises a scrim on the first surface of the tape and on a second surface of the tape.

3. The floor panel of claim 1, wherein the support layer comprises one or more of galvanized steel, aluminum, a reinforced thermoplastic layer, a metal layer, a non-metal layer, a plastic layer, or a tape layer.

4. The floor panel of claim 1, wherein the support layer comprises a second reinforced thermoplastic layer comprising a web of open cell structures formed by reinforcing materials held in place by a thermoplastic material.

5. The floor panel of claim 1, further comprising a cover layer disposed on the tape layer.

6. The floor panel of claim 1, wherein the cover layer comprises one or more of a scrim, a fabric, a plastic, a laminate, wood or combinations thereof.

7. The floor panel of claim 1, wherein the tape is a two layer tape with two individual fibrous layers coupled to each other.

8. The floor panel of claim 7, wherein a first fibrous layer of the tape is coupled to a second fibrous layer of the tape, and wherein a unidirectional fiber orientation in the first fibrous layer is orthogonal to a unidirectional fiber orientation in the second fibrous layer.

9. The floor panel of claim 1, wherein the tape is a four layer tape with four individual fibrous layers coupled to each other.

10. The floor panel of claim 9, wherein a first fibrous layer of the tape is coupled to a second fibrous layer of the tape, and wherein a unidirectional fiber orientation in the first fibrous layer is orthogonal to a unidirectional fiber orientation in the second fibrous layer.

11. The floor panel of claim 10, wherein a third fibrous layer of the tape is coupled to the second fibrous layer of the tape, and wherein a unidirectional fiber orientation in the third fibrous layer is orthogonal to the unidirectional fiber orientation in the second fibrous layer.

12. The floor panel of claim 11, wherein a fourth fibrous layer of the tape is coupled to the third fibrous layer of the tape, and wherein a unidirectional fiber orientation in the fourth fibrous layer is orthogonal to the unidirectional fiber orientation in the third fibrous layer.

13. The floor panel of claim 11, wherein a fourth fibrous layer of the tape is coupled to the third fibrous layer of the tape, and wherein a unidirectional fiber orientation in the fourth fibrous layer is parallel to the unidirectional fiber orientation in the third fibrous layer.

14. The floor panel of claim 10, wherein a third fibrous layer of the tape is coupled to the second fibrous layer of the tape, and wherein a unidirectional fiber orientation in the third fibrous layer is parallel to the unidirectional fiber orientation in the second fibrous layer.

15. The floor panel of claim 14, wherein a fourth fibrous layer of the tape is coupled to the third fibrous layer of the tape, and wherein a unidirectional fiber orientation in the fourth fibrous layer is orthogonal to the unidirectional fiber orientation in the third fibrous layer.

16. The floor panel of claim 14, wherein a fourth fibrous layer of the tape is coupled to the third fibrous layer of the tape, and wherein a unidirectional fiber orientation in the fourth fibrous layer is parallel to the unidirectional fiber orientation in the third fibrous layer.

17. The floor panel of claim 1, wherein the tape is a six layer tape with six individual fibrous layers coupled to each other.

18. The floor panel of claim 16, wherein a first fibrous layer of the tape is coupled to a second fibrous layer of the tape, and wherein a unidirectional fiber orientation in the first fibrous layer is orthogonal to the unidirectional fiber orientation in the second fibrous layer.

19. The floor panel of claim 16, wherein a first fibrous layer of the tape is coupled to a second fibrous layer of the tape, and wherein a unidirectional fiber orientation in the first fibrous layer is parallel to the unidirectional fiber orientation in the second fibrous layer.

20. The floor panel of claim 1, wherein the tape comprises two to six individual fibrous layers each of which comprises a unidirectional fiber orientation, wherein the reinforced thermoplastic layer comprises a polyolefin and inorganic reinforcing fibers, wherein the spacer layer is a foam layer comprising an expandable polystyrene foam and wherein the support layer comprises galvanized steel.

21-54. (canceled)
